(19) United States
(12) Patent Application Publication
(10) Pub. No.: US 2003/0177385 A1
(43) Pub. Date: Sep. 18, 2003

(54) Reverse authentication key exchange

(76) Inventors: James H. Price, Dallas, TX (US); Joel G. Landau, Dallas, TX (US); Tim Barlow, Plano, TX (US)

Correspondence Address: Lawrence R. Youst, Smith, Danamraj & Youst, P.C., LB-15, Suite 1200, 12900 Preston Road, Dallas, TX, 75230, US

(21) Appl. No.: 10/099,735

(22) Filed: Mar. 15, 2002

(51) Int. Cl. H04L 9/00

(52) U.S. Cl. 713/201

(57) ABSTRACT

A system and method for automatically configuring a client device with a user key set when the client device is installed in a data network access device/router at a user's premises, without displaying the key set to the user, or requiring the user to enter one. The client device is preprogrammed with a common key set, and upon installation, automatically requests access to a remote network using the common key set. An authenticator in the network determines whether the common key set is valid, and if so, provides the client device with access to a registration server. The registration server sends a new user key set to the client device and the authenticator. Thereafter, the client device requests access to the network using the new user key set. The authenticator determines whether the new user key set is valid, and if so, provides the client device with full network access.

### BACKGROUND OF THE INVENTION

1. Technical Field of the Invention

This invention relates to data communication networks. More particularly, and not by way of limitation, the present invention is directed to a system and method for configuring and authenticating a client device utilizing a Reverse Authentication Key Exchange (RAKE) methodology.

2. Description of Related Art

Some data networks utilize the Point-to-Point Protocol (PPP) for signaling related to the authentication of remote users before permitting access to the network. The most common variants of the PPP protocol are PPP Over Ethernet (PPPOE), and PPP Over Asynchronous Transfer Mode (ATM) (PPPoA). These protocols are described in two Internet Engineering Task Force Request for Comments, IETF RFC 2516 entitled, “A Method For Transmitting PPP over Ethernet”, and IETF RFC 2364 entitled, “PPP Over AAL5”, respectively. Both IETF RFC 2516 and IETF RFC 2364 are hereby incorporated by reference herein in their entireties.

In PPP authentication, the remote user and a PPP authenticator in the network must have knowledge of the remote user's username and password, referred to as a “key set”. The key set may be defined by the user or may be assigned by the remote network operator at the time the user subscribes. Generally, the PPP authenticator compares a key set stored in an authentication database with the key set included in the remote user's access request message. If the two key sets match, the user is authenticated, and access is granted.

User authentication is performed using one of two standardized protocols, Password Authentication Protocol (PAP) or Challenge Handshake Authentication Protocol (CHAP). The PAP protocol is described in IETF RFC 1334 entitled, “PPP Password Authentication Protocols,” and the CHAP protocol is described in IETF RFC 1994 entitled, “Challenge Handshake Authentication Protocol.” Both IETF RFC 1334 and IETF RFC 1994 are hereby incorporated by reference herein in their entireties.

Of the two authentication protocols, the PAP protocol is most commonly utilized. The PAP protocol transfers the key set “in the clear” using unencrypted text. The remote user sends the key set to the PPP authenticator which compares the received key set with its database to determine a match. Likewise, the CHAP protocol also sends the username portion of the key set in the clear, but provides greater security by hashing the password portion of the key set using a protocol such as MD5. The MD5 protocol is described in IETF RFC 1828 entitled, “IP Authentication Using Keyed MD5,” which is hereby incorporated by reference herein in its entirety. The calculated hashed value, not the password itself, is sent to the PPP authenticator which compares the received username with its database of usernames, and compares the received hash value with its own calculation of the hashed password to determine a match. With either protocol, if a match is found, the user is authenticated, and network access is granted.

In general, a PPP Client is any PPP hardware or software that may be installed in a personal computer (PC) or embedded within a networking device. When a user subscribes to an Internet service through an Internet Service Provider (ISP), the user is generally provided with PPP Client software that runs on his PC. The PPP Client software enables the user to communicate through a modem with an ISP logon server and establish a data session without the user having to know any username or password. Another server within the ISP's domain may act as a registration server, and may perform billing operations as well. Once the session is established between the user and the ISP logon server, a web browser in the user's PC accesses the registration server to subscribe to a desired service. The registration server provides the user with a new username and password that is input into the PPP Client in the PC. The new username and password provide the PPP Client with full access to the network. Thereafter, whenever the user logs on, the PPP Client uses the new username and password.

A problem with the existing methodology is that it only works in the scenario in which a single PC is connected through a non-routing modem (i.e., a bridge) and an analog dial-up connection to the ISP logon server. Such non-routing modems do not include any Internet Protocol (IP) routing capabilities. Thus, legacy systems were designed to work with bridged network devices and analog dial-up connections, and are incompatible with IP routing devices. As Customer Premises Equipment (CPE) devices with IP routing capabilities become more prevalent, this presents a wide-scale problem with no apparent solution. In addition, existing methodologies involve complex systems and customized software, and they add a considerable support burden. The development effort required for each remote network to deploy such systems is extensive, and each network's implementation is entirely different from the implementation of other networks.

If a user desires to have more than one PC connected to the Internet through a single modem, a modem with IP routing capability is required, and the PPP Client must reside in the modem/router. In this case, the user must manually configure the PPP Client in the modem/router with the key set before the initial connection to the remote network can be established. This is because the existing methodology for configuring the PPP Client does not support the use of a CPE device with an embedded PPP Client when the CPE device is operating as an IP router. The manual configuration process is difficult, cumbersome, and confusing, and is beyond the capability of most users. Thus, specialized technical support personnel are required to manually configure the PPP Client in the modem/router.

Therefore, it would be advantageous to have a system and method for configuring and authenticating a PPP Client where exchange of the key set and configuration of the PPP Client occurs in an automated fashion that is compatible with IP routing technology. The present invention provides such a system and method.

### SUMMARY OF THE INVENTION

In one aspect, the present invention is directed to a method of automatically configuring and authenticating a client device installed in a data network access device at a user's premises. The network access device includes an Internet Protocol (IP) router that routes IP signaling between a remote data network and a plurality of users connected to the network access device at the premises. The method includes the steps of preprogramming the client device with a common key set; requesting access to the remote data network by the client device using the preprogrammed common key set for authentication purposes; and determining by an authenticator in the network whether the common key set is valid. If the common key set is valid, the client device is provided with limited network access that enables the client device to access only a registration server. When the registration server is accessed, a new user key set is sent to the client device, and the client device automatically requests access to the remote data network using the new user key set for authentication purposes. The authenticator determines whether the new user key set is valid, and if so, provides the client device with full network access. In this manner, the client device is automatically configured with a user key set without displaying the key set to the user or requiring the user to enter a key set.

In another aspect, the present invention is directed to a system for automatically configuring and authenticating a client device installed in a data network access device at a user's premises. The system includes a client device comprising means for storing a preprogrammed common key set, means for requesting access to the remote data network utilizing the preprogrammed common key set for authentication purposes when the client device is installed in the network access device, and means for automatically requesting access to the remote data network utilizing a new user key set for authentication purposes, the new user key set being received during a registration process. The system also includes an authenticator in the network comprising means for determining whether the common key set is valid, and if so, providing the client device with limited network access enabling the client device to access only a registration server. The authenticator also includes means for determining whether the new user key set is valid, and if so, providing the client device with full network access. Finally, the system includes a registration server for registering the client device in the network, and sending a new user key set to the client device.

In yet another aspect, the present invention is directed to a client device installed in a data network access device at a user's premises. The client device includes means for storing a preprogrammed common key set, means for requesting access to the remote data network utilizing the preprogrammed common key set for authentication purposes when the client device is installed in the network access device, and means for receiving a new user key set from the network. The client device also includes means for replacing the common key set with the received new user key set, and means responsive to receiving the new user key set for automatically requesting access to the remote data network utilizing the new user key set for authentication purposes.

### BRIEF DESCRIPTION OF THE DRAWINGS

The invention will be better understood and its numerous objects and advantages will become more apparent to those skilled in the art by reference to the following drawings, in conjunction with the accompanying specification, in which:

FIGS. 1A and 1B are portions of a signaling diagram illustrating the flow of messages between a PPP Client and the nodes in a data network when performing an embodiment of the method of the present invention.

### DETAILED DESCRIPTION OF EMBODIMENTS

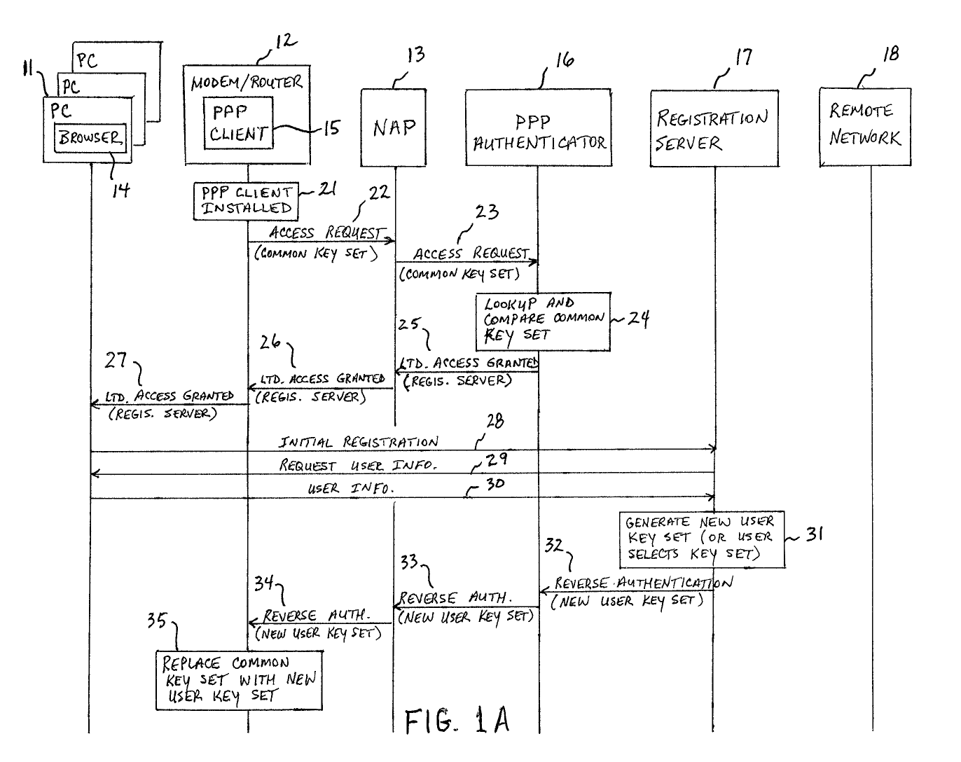

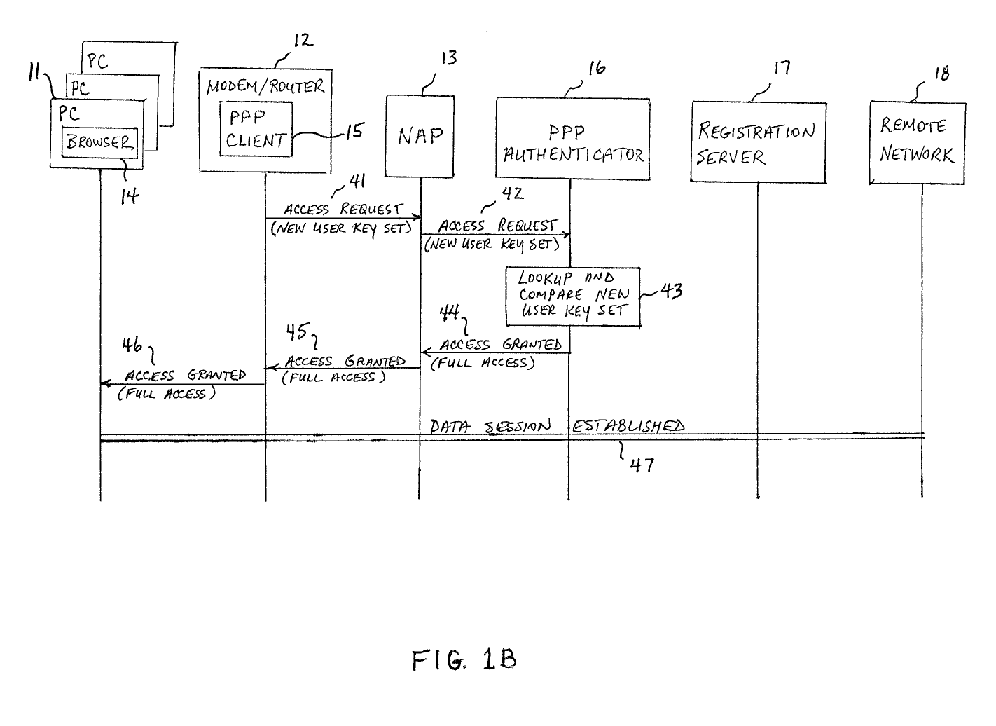

FIGS. 1A and 1B are portions of a signaling diagram illustrating the flow of messages between a PPP Client and the nodes in a data network when performing an embodiment of the method of the present invention. In the network illustrated, a user has a plurality of PCs 11 connected through CPE with routing capabilities, such as a modem/router 12, to a Network Access Point (NAP) 13. Each of the PCs includes a web browser 14, and the modem/router includes a PPP Client 15 loaded or embedded therein. The network also includes a PPP Authenticator 16, a Registration Server 17, and the Remote Network 18. As described in the following paragraphs, it will become obvious that certain modifications have been made to the modem/router/PPP Client, to the PPP Authenticator, and to the Registration Server to enable the method of the present invention to be advantageously practiced. Such modifications are functionally described herein to the level that they may be readily implemented by those skilled in the art.

Referring first to FIG. 1A, at step 21, the PPP Client 15 is installed in the modem/router 12 at the customer premises. At that time, the PPP Client automatically sends an Access Request message 22 to the NAP 13. The PPP Client includes in the Access Request message, a common key set that may be pre-programmed into the PPP Client before it is delivered to the user. The common key set may be specific to each remote network, and for security reasons, is never displayed to the user. At step 23, the NAP forwards the Access Request message to the PPP Authenticator 16. At step 24, the PPP Authenticator looks up the received key set in its authentication database and performs a comparison.

In the present invention, the PPP Authenticator is programmed to recognize that the received key set is a common key set, which provides access only to an associated Registration Server 17. Therefore, at step 25, the PPP Authenticator replies to the NAP that limited network access is granted, and provides the identity of the associated Registration Server. The limited access message is forwarded to the PPP Client 15 at step 26 and to the web browser 14 at step 27.

The web browser 14 then sends an Initial Registration message 28 to the Registration Server 17, and user registration for a requested service begins. During the registration process, the user may be asked at step 29 to enter information required by the remote network to initiate and administer the requested service. This requested information, provided at step 30, may include, for example, address and billing information, Quality of Service (QoS) desired, and other service options.

Upon completion of, or during, the registration process, the Registration Server 17 may automatically generate a new user key set at step 31. Alternatively, the user may select a user key set during or after the registration process which is accepted at step 31 by the Registration Server. At step 32, a reverse authentication process is begun by sending the new user key set from the Registration Server to the PPP Authenticator 16. The PPP Authenticator stores the new user key set in its authentication database as a key set authorizing full access to the Remote Network 18. At step 33, the PPP Authenticator forwards the new user key set to the NAP 13 which, in turn, forwards the new user key set at step 34 to the PPP Client 15. If PAP authentication is utilized, the key set is sent as unencrypted text. If CHAP authentication is utilized, the username is sent as unencrypted text, and the password is sent as a hash value of the original text.

The PPP Client 15 is programmed to accept the reverse authentication attempt at step 35 and to replace the preprogrammed common key set with the new user key set, having recognized that the key set comes from a valid source. The method then moves to FIG. 1B, step 41 where the PPP Client requests access to the Remote Network 18 by sending an Access Request message to the NAP 13. The PPP Client includes in the Access Request message, the new user key set that it received in the reverse authentication. Once again, if PAP authentication is utilized, the key set is sent as unencrypted text. If CHAP authentication is utilized, the username is sent as unencrypted text, and the password is sent as the hash value that was received during the reverse authentication. At step 42, the NAP forwards the Access Request message to the PPP Authenticator 16, and at step 43, the PPP Authenticator looks up the new user key set in its authentication database and performs a comparison.

Since the PPP Authenticator received and stored the new user key set at step 32, the comparison is positive, and the PPP Authenticator sends an Access Granted message 44 to the NAP 13 indicating that full network access is granted. At step 45, the Access Granted message is forwarded to the PPP Client 15, and at step 46, the Access Granted message is forwarded, in turn, to the web browser 14. At step 47, a data session is established between the web browser and the Remote Network 18 for delivery of the requested service.

From the above description, it can be ascertained that the Registration Server 17 may be modified to automatically generate a new user key set when a registration is performed with a user utilizing a common key set. Alternatively, the Registration Server 17 may be modified to accept a new user key set that is selected by the user. The Registration Server is also modified to send the new user key set to the PPP Authenticator 16, initiating the reverse authentication process. Likewise, the PPP Authenticator is modified to accept the new user key set from the Registration Server and to initiate the reverse authentication process with the PPP Client.

Finally, the CPE containing the PPP Client is modified in several ways. First, it is preprogrammed with the common key set before delivery to the user. Second, the PPP Client is programmed to automatically initiate a network access request using the common key set when the PPP Client is installed. The PPP Client continues to use the common key set until a reverse authentication provides a new user key set from a valid source. The PPP Client is also modified to replace the common key set with the new user key set, and to initiate another network access request, this time using the new user key set. Finally, the PPP Client is programmed to store the new user key set for future network access requests.

The method of the present invention, as described above, need only be performed when a user initially registers with the network. Thereafter, whenever the user activates a PPP session to access the network, the same user key set is used for authentication. If the user desires to change the username and/or password at a later date, he sets up a data session in the normal fashion with the Registration Server 17, and then, as shown at step 31, the user selects a new key set. The method is then repeated from steps 32 to 47 to deliver and configure the new key set, and establish a new data session.

The method of Reverse Authentication Key Exchange (RAKE) described herein is compatible with any PPP Client, whether installed and operated on a computer platform, or embedded within a CPE device. In addition, the RAKE method is compatible with any type of CPE technology such as Direct Subscriber Line (DSL), Integrated Services Digital Network (ISDN), T1, analog modem, wireless connection, cable DOCSIS, and other transport and protocol types.

It is thus believed that the operation and construction of the present invention will be apparent from the foregoing description. While the method, apparatus and system shown and described has been characterized as being preferred, it will be readily apparent that various changes and modifications could be made therein without departing from the scope of the invention as defined in the following claims.

What is claimed is:

1. A method of automatically configuring and authenticating a client device installed in a data network access device at a user's premises, said network access device including an Internet Protocol (IP) router that routes IP signaling between a remote data network and a plurality of users connected to the network access device at the premises, said method comprising the steps of:
preprogramming the client device with a common key set;
requesting access to the remote data network by the client device using the preprogrammed common key set for authentication purposes;
determining by an authenticator in the network whether the common key set is valid;
providing the client device with limited network access, said limited access enabling the client device to access only a registration server, upon determining that the common key set is valid;
accessing the registration server;
sending a new user key set to the client device;
automatically requesting access to the remote data network by the client device using the new user key set for authentication purposes;
determining by the authenticator whether the new user key set is valid; and
providing the client device with full network access, upon determining that the new user key set is valid.

2. The method of claim 1 wherein the step of requesting access to the remote data network by the client device using the common key set for authentication purposes includes automatically requesting access to the remote data network by the client device using the common key set for authentication purposes when the client device is installed in the network access device.

3. The method of claim 1 wherein the registration server is associated with the common key set in an authentication database, and the step of providing the client device with limited network access includes providing the client device with access only to a registration server associated with the common key set received from the client device.

4. The method of claim 1 wherein the step of sending a new user key set to the client device includes the steps of:
automatically assigning the new user key set by the registration server; and
sending the new user key set from the registration server to the client device.

5. The method of claim 4 wherein the step of sending a new user key set to the client device also includes sending the new user key set from the registration server to the authenticator.

6. The method of claim 1 wherein the step of sending a new user key set to the client device includes sending a new user key set from the authenticator to the client device.

7. The method of claim 1 wherein the step of accessing the registration server includes registering one of the users with the registration server, said registering step including selecting the new user key set by the registering user.

8. The method of claim 7 wherein the step of sending a new user key set to the client device includes sending the new user key set selected by the user from the registration server to the client device and to the authenticator.

9. The method of claim 1 wherein the step of automatically requesting access to the remote data network by the client device using the new user key set for authentication purposes includes the steps of:
receiving the new user key set in the client device;
authenticating by the client device that the new user key set is received from a valid source; and
automatically requesting access to the remote data network by the client device using the new user key set, upon authenticating that the new user key set is received from a valid source.

10. A system for automatically configuring and authenticating a client device installed in a data network access device at a user's premises, said network access device including an Internet Protocol (IP) router that routes IP signaling between a remote data network and a plurality of users connected to the network access device at the premises, said system comprising:
a client device comprising:
means for storing a preprogrammed common key set;
means for requesting access to the remote data network utilizing the preprogrammed common key set for authentication purposes when the client device is installed in the network access device; and
means for automatically requesting access to the remote data network utilizing a new user key set for authentication purposes, said new user key set being received during a registration process;
an authenticator in the network comprising:
means for determining whether the common key set is valid, and providing the client device with limited network access enabling the client device to access only a registration server, upon determining that the common key set is valid; and
means for determining whether the new user key set is valid, and providing the client device with full network access, upon determining that the new user key set is valid; and
a registration server for registering the client device in the network, and sending a new user key set to the client device.

11. The system of claim 10 wherein the authenticator includes an authentication database that associates a plurality of common key sets with a plurality of registration servers.

12. The system of claim 10 wherein the client device also includes means for authenticating that the new user key set is received from a valid source.

13. The system of claim 10 wherein the client device utilizes the Point-to-Point Protocol (PPP) for signaling with the authenticator and registration server.

14. The system of claim 13 wherein the client device is installed in a Customer Premises Equipment (CPE) comprising a Digital Subscriber Line (DSL) modem and IP router.

15. A client device installed in a data network access device at a user's premises, said network access device including an Internet Protocol (IP) router that routes IP signaling between a remote data network and a plurality of users connected to the network access device at the premises, said client device comprising:
means for storing a preprogrammed common key set;
means for requesting access to the remote data network utilizing the preprogrammed common key set for authentication purposes when the client device is installed in the network access device;
means for receiving a new user key set from the network;
means for replacing the common key set with the received new user key set; and
means responsive to receiving the new user key set for automatically requesting access to the remote data network utilizing the new user key set for authentication purposes.

16. The client device of claim 15 further comprising means for authenticating that the new user key set is received from a valid source.

17. The client device of claim 15 wherein the client device utilizes the Point-to-Point Protocol (PPP) for signaling with the authenticator and registration server.

18. The client device of claim 17 wherein the client device is installed in a Customer Premises Equipment (CPE) comprising a Digital Subscriber Line (DSL) modem and IP router.
